(19) United States
(12) Patent Application Publication
(10) Pub. No.: US 2008/0197718 A1
(43) Pub. Date: Aug. 21, 2008

(54) ELECTRICAL MACHINE WITH FERROFLUID COMPONENTS

(75) Inventor: NORBERT WOHNER, Heustreu (DE)

Correspondence Address: Henry M. Feiereisen;Henry M. Feiereisen, LLC, Suite 4714, 350 Fifth Avenue, New York, NY, 10118, US

(73) Assignee: Siemens Aktiengesellschaft, Munchen (DE)

(21) Appl. No.: 12/029,769

(22) Filed: Feb. 12, 2008

(30) Foreign Application Priority Data
Feb. 15, 2007 (DE) 10 2007 007 559.8

(51) Int. Cl. H02K 9/00; H02K 1/00; H02K 21/12

(52) U.S. Cl. 310/11; 310/54; 310/156.01

(57) ABSTRACT

An electrical machine includes a primary part and a secondary part which are spaced apart from one another by an air gap and capable of moving relative to one another. The primary part and/or the secondary part is/are constructed for generating magnetic or electromagnetic fields, with the primary part and the secondary part having flux-concentrating means for guiding a magnetic main flux. At least portions of the magnetic main flux are guided by a ferrofluid.

### CROSS-REFERENCES TO RELATED APPLICATIONS

This application claims the priority of German Patent Application, Serial No. 10 2007 007 559.8, filed Feb. 15, 2007, pursuant to 35 U.S.C. 119(a)-(d), the content of which is incorporated herein by reference in its entirety as if fully set forth herein.

### BACKGROUND OF THE INVENTION

The present invention relates, in general to the filed of electrical machines.

Nothing in the following discussion of the state of the art is to be construed as an admission of prior art.

Electrical machines of a type involved here have a primary part and a secondary part which are capable of moving relative to one another. The secondary part may be, for example, a rotor of an electrical machine operating in rotary fashion or a moving part of a linear motor. The primary part is formed, for example, as a stator or as a fixed part with a single-phase or polyphase winding. In linear motors, both the primary part and the secondary part can be formed as the moving part. In rotary electrical machines, the stator is opposite the rotor, the stator and the rotor being spaced apart from one another by an air gap. Both the stator and the rotor have magnetic means for generating and/or guiding magnetic fields or the magnetic flux.

The stator and the rotor for electrical machines generally have a laminate stack, comprised of individual electrical laminates, with the winding or also permanent magnets for generating magnetic fields being arranged on the laminate stack. The individual laminates for the stator and the rotor are generally stamped individually and are assembled, for example, by means of stamped stacking, welding or clamping to form laminate stacks. A high degree of manufacturing complexity results since suitable stamping dies, for example progressive dies, are required for stamping the individual laminates, various stamping dies being required for each embodiment of an electrical machine, such as two-pole, four-pole etc., for example.

In order to guide the magnetic main flux between the stator and the rotor, toothed laminates are conventionally used in the case of stators/rotors which bear windings. The winding is arranged in the slots of the laminates or the laminate stack. Once the slots have been insulated, the winding is introduced, for example by means of being drawn in.

In a laminate stack made from iron, substantially two types of losses occur. The majority of the iron losses is produced by the remagnetization of the laminates in clock with the system frequency. Furthermore, iron losses occur as a result of eddy currents in the laminate stack. In order to keep the resulting losses as low as possible, the laminate stacks should be produced from individual laminates which are insulated from one another and are as thin as possible. The thinner the individual laminates are designed to be, the lower the losses are.

It is possible to produce the stator and rotor laminate stack, for example, from composite materials, such as plastics composite material, for example. As a result, the use of stamping dies can be avoided, but then injection-molding dies are required.

It would therefore be desirable and advantageous to provide an improved electrical machine which obviates prior art shortcomings and which is constructed such that the primary part and/or secondary part have as few losses as possible as a result of remagnetization and eddy currents, and yet is simple in structure and cost-effectively to manufacture.

### SUMMARY OF THE INVENTION

According to one aspect of the present invention, an electrical machine includes a primary part, and a secondary part, which are spaced apart from one another by an air gap and capable of moving relative to one another, wherein the primary part and/or the secondary part has/have means to generate magnetic or electromagnetic fields, wherein the primary part and the secondary part have each flux-concentrating means for guiding a magnetic main flux, and wherein at least portions of the magnetic main flux are guided by a ferrofluid. Examples for means to generate magnetic or electromagnetic fields may include a single-phase or polyphase winding or permanent magnets.

The electrical machine according to the invention may be a rotary or a linear machine. When a rotary electrical machine is involved, the primary part may be formed as the stator and the secondary part may be formed as the rotor.

The magnetic main flux interlinks the magnetic or electromagnetic fields of the primary and the secondary part beyond the air gap. In addition, leakage fluxes exist which are only interlinked in the primary or secondary part and do not go over the air gap.

According to the invention, at least portions of the magnetic main flux between the primary part and the secondary part are guided by a ferrofluid. The magnetic main flux is accordingly not guided exclusively by means of the laminate stacks, but entirely or partially by means of a flux-concentrating liquid, the ferrofluid. Ferrofluid relates to a liquid which reacts to a magnetic field. Ferrofluid substances are made of magnetic particles, which are suspended colloidally in a carrier liquid. The particles are generally stabilized by a polymeric surface coating.

Ferrofluids are stable dispersions, i.e. the particles do not settle with time and, even in the case of extremely strong magnetic fields, do not become attached to one another and become separated from the liquid as another phase.

Ferrofluids are superparamagnetic and have a very low hysteresis. The particles normally comprise iron, magnetite or cobalt and typically have a diameter of from 5 nm to 10 nm (nanometers). The surrounding liquid is, for example, oil or water, less often wax. In addition, surfactants are added to the liquid in order to achieve stability of the suspension.

According to another feature of the present invention, at least one of the flux-concentrating means of the primary part and the secondary part may be formed by the ferrofluid. In other words, either only the primary part or only the secondary part or the primary part and the secondary part has/have ferrofluid. For this purpose, the primary part or the secondary part or each of both parts can have at least one filling area for accommodating the ferrofluid. Such a filling area is formed, for example, by the interior of a hollow body.

According to another feature of the present invention, the primary part may have a hollow-cylindrical winding support, with a single-phase or polyphase winding being arranged on the winding support. The winding can be fitted to the outer face of the hollow cylinder in the form of a concentrated winding (field-coil winding) or a distributed winding (lap winding). Suitably, the winding support has a plurality of pins for accommodating and fixing the winding. The pins may be arranged at the end-side regions of the hollow cylinder, so that the individual coils of the winding are wound around the pins. The production of the winding is simplified by the direct winding of the winding support since no coils need to be produced and then fitted separately. Furthermore, slots are not required for the winding since the coils are simply wound around the pins.

According to another feature of the present invention, the primary part may have a hollow-cylindrical outer sleeve which is designed such that the winding support with the winding arranged can be arranged within the outer sleeve.

If the winding support with the winding arranged is arranged within the outer sleeve, the filling area for the ferrofluid can be clamped between the winding support and the outer sleeve.

According to another feature of the present invention, the winding support, also referred to as the inner sleeve, and the outer sleeve may have substantially a same axial length. Sealing means may be arranged at both end sides of the inner sleeve and the outer sleeve, so that the winding support, the outer sleeve and the sealing means form a closed contour. An example of sealing means includes sealing plates made from plastic, which are annular or circular in shape, with the annular sealing plate terminating with the inner and the outer sleeve.

Suitably, the end-side sealing means are designed in such a way that a winding cable, in particular a winding end, of the electrical machine, in particular of the primary part, can be passed out. The sealing means, for example sealing plates, can have openings, such as bores, through which the winding end is passed out. Once the winding end has been passed out through a bore, the latter needs to be sealed, i.e. closed, in a liquid-tight manner, since the ferrofluid is located in the interior of the inner sleeve, outer sleeve and sealing plates. It is possible for parts of the end-side seals to already be fitted on the inner or outer sleeve. The primary part is supplied with electrical current via the winding cable which has been passed out.

Once the winding has been arranged on the winding support, i.e. the inner sleeve, the outer sleeve has been pushed over the winding and the sealing means have been arranged, a winding cable having been passed to the outside through the end-side sealing means or the outer sleeve, the ferrofluid is introduced into the resulting filling area between the winding support and the outer sleeve. In this case, the opening, which is used for passing through the winding cable, can at the same time act as a filling opening for the ferrofluid. In this case, the opening is only closed in a liquid-tight manner once the ferrofluid has been introduced. However, other filling openings for the ferrofluid can be formed. For example, it is possible for initially only one of the two end-side sealing means to be arranged, then for the cylindrical body to be positioned upright and the ferrofluid to be introduced and finally for the second sealing means, effectively in the form of a lid, to be fitted.

The composition of the ferrofluid can be adapted for the respective application. Adapting the ferrofluid in this way can be achieved, for example, by the number of magnetic particles. The ferrofluid is in the form of, for example, a ferromagnetic or superparamagnetic ferrofluid.

As a result of the use of flux-concentrating liquids, i.e. of ferrofluids, only very low remagnetization and eddy current losses occur in the primary part and/or secondary part, with the result that an electrical machine with a high degree of efficiency can be provided.

Since the winding is surrounded on all sides by the ferrofluid, an optimum magnetic main flux results since there are no air gaps in the primary and/or secondary part. The slot fill factor is therefore very high and is ideally 100%. In comparison with conventional machines, the slot fill factor is substantially increased, as a result of which the efficiency of the machine is likewise increased.

For the case in which the winding is intended to be insulated from the ferrofluid, this can be carried out after production of the winding, for example by casting of the winding.

According to another feature of the present invention, the winding support (inner sleeve) and the outer sleeve may be plastic moldings, i.e. produced from plastic. The shaping for the primary and/or secondary part is therefore defined by moldings. This results in a simplified production process using few tools for the primary and/or secondary stack since the stamping of individual laminates and the stacking process are dispensed with. Furthermore, free shaping can be selected. The primary and/or secondary part can be produced, for example, by means of injection molding. As a result of the use of cost-effective injection-molded parts, complex and therefore expensive stamping techniques are no longer required.

According to another feature of the present invention, the ferrofluid may at the same time form a heat-dissipating medium. Therefore, the invention provides the possibility of using the ferrofluid which is present in any case at the same time also for cooling tasks. If the ferrofluid at the same time also performs cooling functions, the ferrofluid generally needs to be recooled, for example by means of a heat exchanger and a secondary cooling liquid cycle or by means of a heat exchanger using air.

Since the winding lies directly in the ferrofluid, the heat losses produced in the winding can be dissipated directly via the ferrofluid. As a result of this optimized dissipation of heat losses, the efficiency or the power of the electrical machine is increased.

According to another feature of the present invention, the ferrofluid can be linked directly or indirectly to a cooling cycle of the electrical machine. For example, the ferrofluid in the stator stack is connected to a cooling cycle of the machine, the ferrofluid being the heat carrier. The heated ferrofluid is pumped away out of the stator stack and replaced by cool ferrofluid. In particular, the filling area and the ferrofluid are at the same time a constituent part of a cooling system of the machine. The cooling system of the machine can function substantially exclusively with the ferrofluid. However, combinations with other, liquid or gaseous cooling media are also possible.

The electrical machine according to the invention can be an electric motor or a generator for generating current or else a combination of the two which functions either as a motor or as a generator.

The electrical machine according to the invention may be constructed in the form of a permanent-magnet synchronous machine. The electrical machine may be in the form of an external-rotor or internal-rotor machine. The stator, i.e. the primary part, may be constructed in the form of a ferrofluid component. The rotor, i.e. the secondary part, can be a conventional laminate stack with permanent magnets. In addition, it is possible for the rotor of an asynchronous machine to be in the form of a ferrofluid component, for example the finished squirrel cage being inserted into a sleeve which is filled with ferrofluid once closed.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a perspective view of a winding support for a primary part of an electrical machine according to the invention;

FIG. 2 shows a side view of the winding support shown in FIG. 1;

FIG. 3 shows a detail of the winding support shown in FIG. 2;

FIG. 4 shows a perspective view of an outer sleeve for a primary part of an electrical machine according to the invention;

FIG. 5 shows a perspective view of the outer sleeve of FIG. 4 with sealing means;

FIG. 6 shows a perspective view of a primary part of an electrical machine according to the invention;

FIG. 7 shows an end-side view of the primary part shown in FIG. 6;

FIG. 8 shows a detail of a primary part with cable bushing;

FIG. 9 shows a primary part of an electrical machine according to the invention; and

FIG. 10 shows an electrical machine according to the invention.

### DETAILED DESCRIPTION OF PREFERRED EMBODIMENTS

Throughout all the figures same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

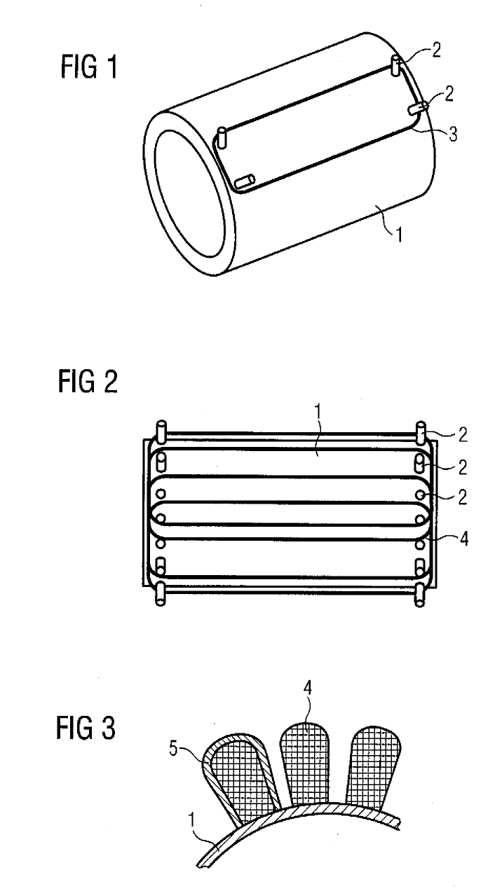

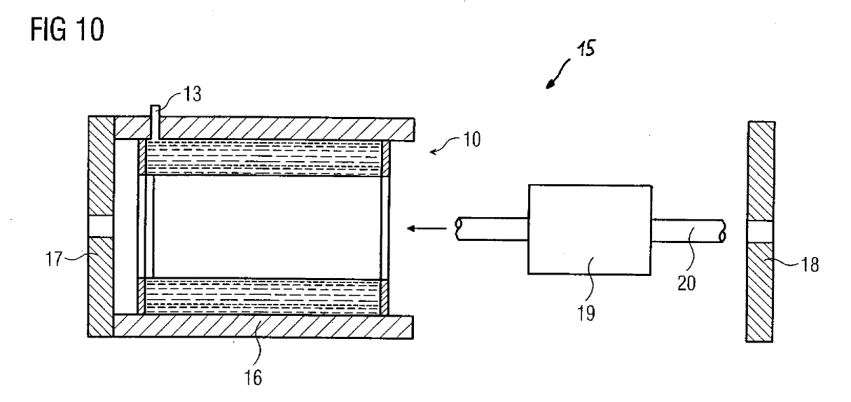

Turning now to the drawing, and in particular to FIG. 1, there is shown a perspective view of a winding support 1 for a primary part 10 (not shown here) of an electrical machine 15 (FIG. 10) according to the invention. The winding support 1 is hollow-cylindrical and has a plurality of pins 2 for accommodating and fixing a winding. FIG. 1 shows an individual coil 3, which is arranged on the pins 2. The winding support 1 with the pins 2 is in the form of a plastic molding.

FIG. 2 shows the winding support 1 with a complete winding 4. The winding 4 is finted to the outer face of the hollow-cylindrical winding support 1 in the form of a lap winding or distributed winding. The pins 2 are arranged at the end-side regions of the winding support 1.

FIG. 3 shows a detail of the winding support 1 with the winding 4. The pins 2 are not shown. The winding 4 is enveloped by the insulation 5. The winding 4 is insulated from the ferrofluid (not shown) by the insulation 5, for example the winding is cast or encapsulated by injection molding.

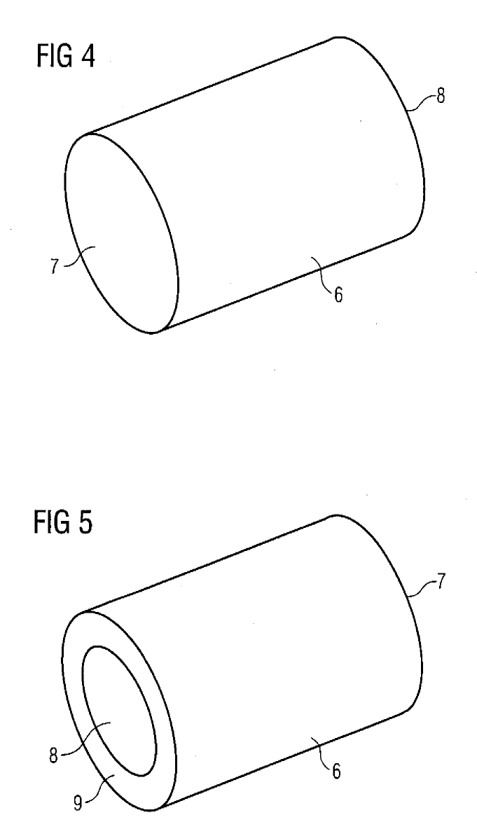

FIG. 4 shows a perspective view of an outer sleeve 6 for a primary part 10 (not shown) of an electrical machine 15 (not shown) according to the invention. The outer sleeve 6 is likewise hollow-cylindrical, the outer sleeve 6 being designed such that the winding support 1 with the winding 4 arranged can be arranged within the outer sleeve. The outer sleeve 6 has the A side 7 and the B side 8. The A side 7 is substantially completely open, with the result that the winding support 1 can be inserted into the outer sleeve 6 from the A side 7. The B side 8, on the other hand, is designed in such a way that sealing means 9 have already been arranged, as shown in FIG. 5. The winding support 1 is inserted into the outer sleeve 6 into the sealing means 9 from the A side 7, with the result that a liquid-tight contour is already realized at the B side 8. The connection between the winding support 1 and the sealing means 9, which is in the form of a sealing ring, is in the form of a press fit, for example.

The outer sleeve 6 is in the form of a plastic molding, the sealing means 9 being designed to be integral with the outer sleeve 6. The outer sleeve 6 and the sealing means 9 are an injection-molded part.

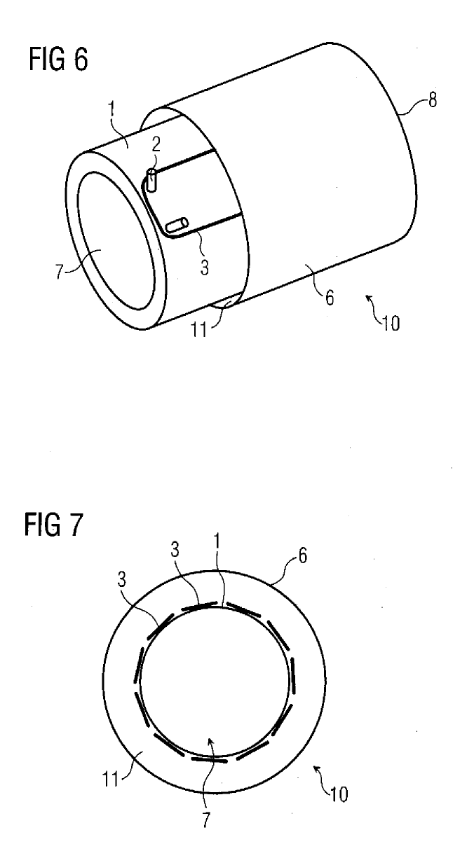

FIG. 6 shows a perspective view of the primary part 10 of an electrical machine 15 (not illustrated) according to the invention. The winding support 1 with the pins 2 and a coil 3, which is referred to as a winding, and the outer sleeve 6 have substantially the same axial length. If the winding support 1 with the winding arranged is arranged within the outer sleeve 6, the filling area 11 for the ferrofluid is clamped between the winding support 1 and the outer sleeve 6. Sealing means 9 (not shown) are arranged on the two sides 7 and 8, with the result that the winding support 1, the outer sleeve 6 and the sealing means 9 form a closed contour.

FIG. 7 shows an end-side view of the primary part 10 upon an area of the A side 7 of the primary part 10. The coils 3 are in the form of a concentrated winding or tooth-wound coils. The filling area 11 is provided for the ferrofluid. It can easily be seen in FIG. 6 that the coils 3 or the winding 4 lie completely in the filling area 11 and are therefore completely surrounded by the ferrofluid once the ferrofluid has been introduced. Since the coils 3 are surrounded on all sides by the ferrofluid, an optimum magnetic main flux results, since there are no air gaps in the primary part 10. The slot fill factor is therefore very high and is ideally 100%. The ferrofluid (not shown) in the filling area 11 is at the same time in the form of a heat-dissipating medium. As a result of this direct and therefore optimized dissipation of heat losses from the winding 4, the efficiency and the power are increased.

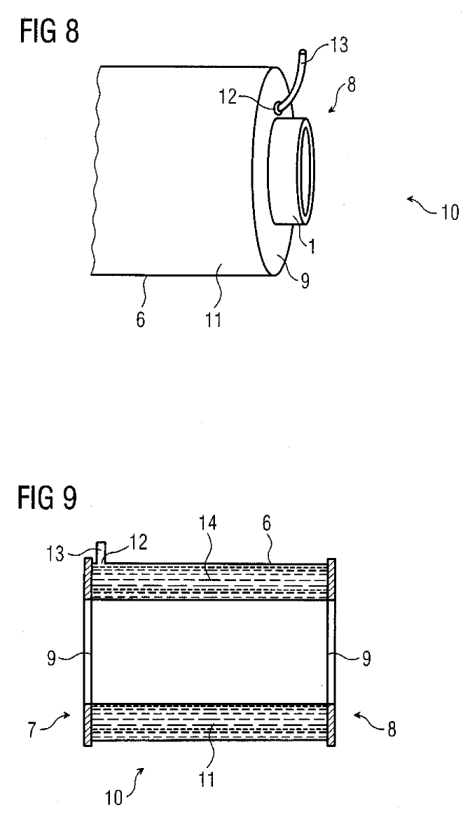

FIG. 8 shows a detail of a primary part 10 with a cable bushing. The end-side sealing means 9 on the B side 8 of the outer sleeve 6 and the winding support 1 has the opening 12, through which the winding phase or the winding cable 13 of the primary part 10 is passed out. The primary part 10 is supplied with electrical current via the winding cable 13 which has been passed out. Once the winding cable 13 has been passed out through the opening 12, this opening needs to be sealed, i.e. closed, in a liquid-tight manner, since the ferrofluid is located in the interior of the winding support 1, the outer sleeve 6 and the sealing means 9. The ferrofluid (not shown) can be introduced into the schematically indicated filling area 11 via the opening 12. The opening therefore performs two functions, namely cable bushing and filling opening.

FIG. 9 shows a complete primary part 10. The primary part 10 has the opening 12 for passing out the winding cable 13, this time on the A side 7, the winding cable 13 being guided upwards, i.e. above, during operation of the electrical machine. Furthermore, the two end-side sealing means 9 are shown as connecting the outer sleeve 6 to the inner winding support 1, as a result of which a closed contour is produced. The filling area 11 with the ferrofluid 14 is indicated schematically.

FIG. 10 shows an electrical machine 15 according to the invention. The primary part 10 is arranged in the hollow-cylindrical housing 16, the housing 16 having an opening for passing through the winding cable 13. The opening of the housing 16 substantially corresponds to the opening 12 of the outer sleeve, the two openings being arranged next to one another, so that the winding cable 13 can be passed out. The electrical machine 15 is in the form of an internal-rotor machine, with the result that the cylindrical secondary part 19, in the form of a rotor, is arranged within the primary part 10, the primary and secondary parts 10, 19 being spaced apart from one another by means of an air gap. The rotor 19 is arranged on a rotor shaft 20, which is mounted in the mount plates 17 and 18.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. An electrical machine, comprising:
a primary part;
a secondary part, the primary part and the secondary part being spaced apart from one another by an air gap and being capable of moving relative to one another,
wherein at least one member selected from the group consisting of the primary part and the secondary part is constructed to generate magnetic or electromagnetic fields,
wherein the primary part and the secondary part have each flux-concentrating means for guiding a magnetic main flux,
wherein at least portions of the magnetic main flux are guided by a ferrofluid.

2. The electrical machine of claim 1, wherein at least one of the flux-concentrating means of the primary part and the secondary part is formed by the ferrofluid.

3. The electrical machine of claim 1, wherein the primary part has at least one filling area for accommodating the ferrofluid.

4. The electrical machine of claim 1, wherein the secondary part has at least one filling area for accommodating the ferrofluid.

5. The electrical machine of claim 1, wherein the member is the primary part, said primary part having a hollow-cylindrical winding support, and a single-phase or polyphase winding for generating magnetic fields, with the winding being arranged on the winding support.

6. The electrical machine of claim 5, wherein the primary part has a hollow-cylindrical outer sleeve which is constructed for accommodation of the winding support with the winding.

7. The electrical machine of claim 6, wherein the primary part has at least one filling area for accommodating the ferrofluid, said filling area being clamped between the winding support and the outer sleeve.

8. The electrical machine of claim 6, wherein the winding support and the outer sleeve have a substantially same axial length, and further comprising sealing means arranged on end sides of the winding support and the outer sleeve, so that the winding support, the outer sleeve and the sealing means jointly form a closed contour.

9. The electrical machine of claim 6, wherein the winding support and the outer sleeve are plastic moldings.

10. The electrical machine of claim 5, wherein the winding support has a plurality of pins for accommodating and fixing the winding.

11. The electrical machine of claim 1, wherein the ferrofluid is capable to act as a heat-dissipating medium.

12. The electrical machine of claim 1, further comprising a cooling system, said ferrofluid being a component of the cooling system.

13. The electrical machine of claim 1, wherein the secondary part has permanent magnets for generating the magnetic fields.

14. The electrical machine of claim 1, constructed as a rotary electrical machine, with the primary part forming a stator, and the secondary part forming a rotor.
